(19) United States
(12) Patent Application Publication
(10) Pub. No.: US 2006/0064308 A1
(43) Pub. Date: Mar. 23, 2006

(54) Method, device and system for a machine-readable code enabled device enabling E-commerce transactions

(76) Inventor: Oliver Foehr, Mercer Island, WA (US)

Correspondence Address: BARNES & THORNBURG, 600 1ST SOURCE BANK CENTER, 100 NORTH MICHIGAN, SOUTH BEND, IN, 466011632, US

(21) Appl. No.: 10/932,465

(22) Filed: Sep. 2, 2004

(51) Int. Cl. G06Q 99/00

(52) U.S. Cl. 705/1

(57) ABSTRACT

A method, device and system for enabling electronic commerce transactions. The method in a data processing system comprises the steps of displaying vendor information in a readable format to a user. Next, the vendor information is read and transmitted to a server. The server retrieves the vendor data associated with the vendor information from the server and compares the vendor data with the vendor information to construct a vendor output. The server then transmits the vendor output to the user. The user executes a transaction with the server wherein the transaction is based in response to the vendor output. The data processing system comprises a portable device having a reader being configured to read vendor information. A server in communication with the portable device receives the vendor information from the portable device and compares the vendor information with vendor data stored in a memory. A processor in communication with the server instructs a vendor compilation program to construct a vendor output based on the comparison of the vendor information with the vendor data.

### PRIORITY CLAIM

This application claims priority to the U.S. Provisional Application filed on Sep. 5, 2003 having Ser. No. 60/500,782 to the extent permitted by law.

### BACKGROUND

The present disclosure relates to a method, device and system for processing information by a portable device handled by a user. In particular, the present disclosure relates to using the portable device to acquire information in order to perform transactions with a server wherein the transactions are based on the information.

Currently, electronic commerce through a server such as the Internet allows transactions between a buyer and at least one vendor. In a type of electronic commerce transaction, the vendor, such as a retailer, displays products and/or information relating to the products to the buyer on the server such as a website. The buyer accesses the vendor information through a computer or personal digital assistant (PDA) and submits authorization to buy the specific product displayed by the vendor.

In electronic commerce transactions, however, the products available to the buyer are limited as to those products specifically offered on-line by the vendor. The vendor provides buyer access to the specific products available only on the server, whereas these products may not be updated in a convenient cycle for a particular buyer. As such, the vendor may lose transactions because certain products were not displayed on the server. Still further, since the vendor provides only on-line access to the specific products, the vendor may lose transactions when a buyer views a product advertisement not associated with the server, such as newspaper advertisements, periodical advertisements or product flyers.

### SUMMARY

The present disclosure relates to a method, device and system for processing information by a portable device handled by a user. In an embodiment, the present disclosure relates to a method in a data processing system, wherein the method comprises the steps of displaying vendor information in a readable format to a portable device handled by a user. The portable device acquires the vendor information and transmits the vendor information to a server. Upon receiving the vendor information, the server retrieves vendor data associated with the vendor information. Next, the server compares the vendor data with the vendor information to construct a vendor output. The vendor output is transmitted to the user wherein the user executes a transaction with the server based in response to the vendor output.

In another embodiment, the present disclosure relates to a data processing system which comprises a portable device having a reader, wherein the reader is configured to read and acquire vendor information. The system further comprises a server having a processor and a memory coupled to the processor. The server is in communication with the portable device via one of any number of suitable methods. The server may include a back end structure which may include additional memory and a vendor compilation program. Upon receipt of vendor information from the portable device, the processor executing the vendor compilation program, compares the vendor information with vendor data stored in the memory. A vendor output is constructed, or generated, as a result of the comparison of the vendor information with the vendor data. The vendor data, received via the portable device, may then be utilized by the user to execute a transaction

Additional features will become apparent to those skilled in the art upon consideration of the following detailed description and drawings.

### BRIEF DESCRIPTION OF THE DRAWINGS

The detailed description particularly refers to the accompanying figures in which:

FIG. 1 is a diagrammatic view of components of the current disclosure; and

FIG. 2 is a flowchart of a method for processing data by the system of FIG. 1.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

For purpose of this disclosure, the term “product” is not limited to goods, but can include services as well, as long as the goods or services can be labeled or identified through vendor information or the like. The device of the present disclosure relates to a portable device enabled to read and to process information. The present disclosure utilizes any portable electronic device including but not limited to cell phones, personal digital assistants, mobile computers, electronic watches, portable music players, or a dedicated electronic device for reading vendor information. In addition, the present disclosure also relates to vendor information which includes but is not limited to any type of electrical code or machine readable code, including barcodes, character recognition, or codes transmitted using any suitable radio-frequency communications method, such as, for example, BlueTooth and radio frequency identification tags.

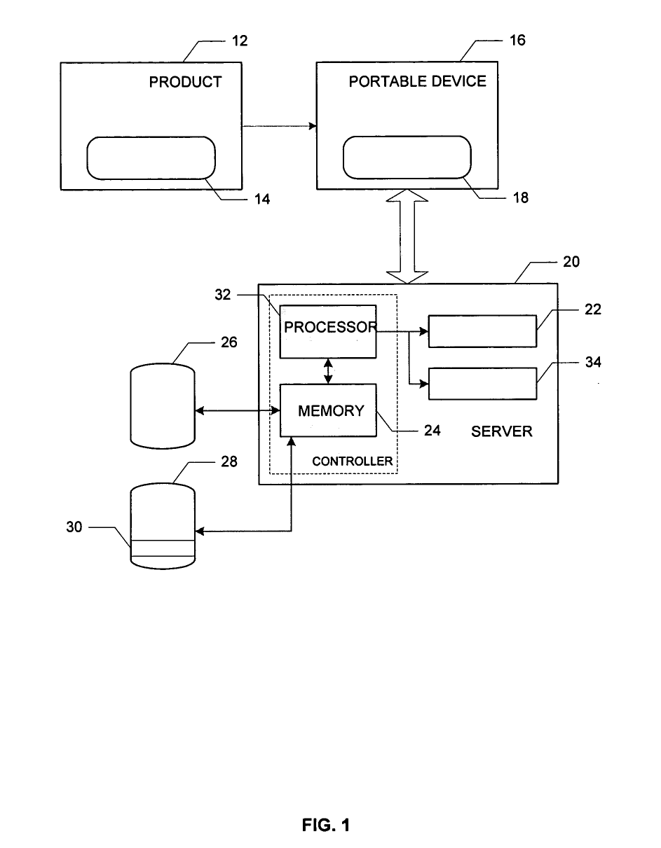

Referring now to the Figures, FIG. 1 illustrates a diagrammatic view of an embodiment of a data processing system 10 according to the present disclosure. A product 12, such as an item for purchase, contains vendor information 14 such as a barcode which identifies the product 12. The vendor information 14 is configured as, and is displayed, in an electronic format or a machine readable format to the user. Such barcode markings are ubiquitous because most commercial vendors use UPC barcodes for inventory and ordering control purposes. Accordingly, the system 10 of the present disclosure is compatible with such commonly available barcode systems.

As illustrated, the system 10 includes a portable device 16, wherein the portable device 16 includes a reader 18 which is configured to read the vendor information 14. The portable device 16 may include any commercially available cell phone. The reader 18 may include a barcode reader having optical capabilities, or a digital camera capable of digitally acquiring the vendor information 14 and then translating the vendor information 14 into a corresponding alphanumeric code using translation software.

In an embodiment, the portable device 16 and reader 18 may include a cellular phone and digital camera, a display and browser software, wherein the display and browser may have, in an embodiment, a minimum resolution of 640×480 pixels (VGA) displaying a plurality of colors. Use of the portable device 16 may be controlled by some authentication method such as lock code or user name and password. Additional security codes for other individual or groups of features may also be assigned to the portable device 16. In an embodiment, the portable device 16 includes data transfer capabilities, i.e. data can be transferred via text messaging capability, web surfing capability and digitized voice processing capability.

The portable device 16 uses the data transfer capabilities to communicate with a server 20. In an embodiment, the portable device 14 and server 18 are configured to communicate wirelessly with each other. The server 20 may include a computer system or network of computers of known construction that process data requests by back end infrastructure such as a vendor compilation program 22 which may be connected to a database system. The communications network used by or with the server 20 may be the Internet, or some other private network or intranet. The server 20 also includes a memory 24 which stores vendor data 26 and user data 28, and at least one processor 32 (e.g., a microprocessor) for executing various programs such as the vendor compilation program 22. The databases for the vendor data 26 and the user data 28 contain information such as user preferences, vendor mappings, product-to-UPC mappings, and other data such as billing information 30 relating to the user. The vendor and user data 26, 28 are designed such that vendors can interface with the data, by implementing industry standard protocols such as XML. Additionally, the vendor data 26 is dynamically updated by the vendor to provide real time information to the user. The vendor compilation program 22 is configured to receive the vendor information 14 from the portable device 16 via the server 20, wherein the vendor compilation program 22 is executed to compare the vendor information 14 with the vendor data 26 stored in the memory 24.

In an embodiment, the server 20 provides functionality such as: making users unidentifiable to vendors, also known as “anonymizing,” product matching, handling reverse auctions, providing for secure transactions and billing for the secure transactions. The server 20 may also include a web interface for vendor and consumer account management. The server 20 may have stored thereon, or be in network communication with a computer storing the user data 28 such as name, address, payment information such as credit card number or e-wallet information and buying preferences of the user. As such, the user data 28 may be transmitted to the server 20 in addition to being stored in the memory 24 of the server 20.

As mentioned above, the server 20 includes at least one processor 32. Among other things, the processor 32 is configured to cause the vendor compilation program 22 to construct a vendor output 34 based on the comparison of the vendor information 14 with the vendor data 26. The server 20 then transmits the vendor output 34 to the portable device 16, wherein the portable device 16 is configured to relay the vendor output 34 to the user. In an embodiment, the portable device 16 may visually display the vendor output 34 to the user. In another embodiment, the portable device 16 may audibly communicate the vendor output 34 to the user.

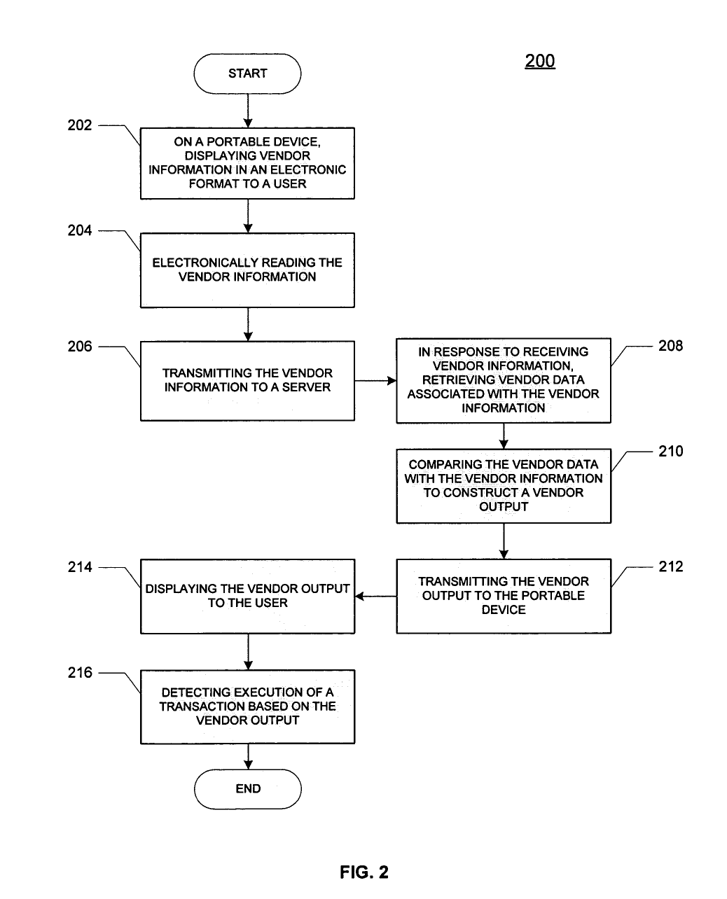

Turning to FIG. 2, a method of processing data 200 by the system 10 is shown. During use, the vendor information 14 relating to the product 12 is displayed in a readable format such as the machine readable barcode displayed to the user (step 202). The vendor information 14 may be displayed in a variety of formats. For example, the vendor information 14 may be displayed in an electronic readable format on a computer screen such as an on-line listing for the product 12. Alternatively, the vendor information 14 may be displayed as a barcode in a newspaper advertisement, in a retailer catalog, in a point of purchase display or on a store shelf.

After displaying the vendor information 14 in a readable format to the user, the reader 18 acquires the vendor information 14 (step 204). The portable device 16 may then translate the vendor information 14 acquired by the reader 18 into an alphanumeric code. After translating the vendor information 14, the portable device 16 transmits the vendor information 14 to the server 20 (step 206). As previously mentioned, transmission may be enabled via one of any number of suitable methods using one of any number of suitable protocols, for example using a Bluetooth wireless link. Error checking such as checksum comparison may be implemented to verify that the scanned vendor information 14 is readable and usable by the server 20 or otherwise complies with the appropriate standard such as the UPC standard. If the scanned vendor information 14 is compliant with the UPC system, or other selected product identification mapping standard, the product identity may be determined by the server 20 from the vendor information 26. User preferences, such as location, delivery options and billing information, may be retrieved by referencing the user data 28. Alternatively, user data 28 may be stored on and transmitted by the portable device 16. User preferences can be adjusted using any known account manager interface.

After receiving the vendor information 14 from the portable device 16, the processor 32 retrieves the vendor data 26 from the memory 24 (step 208) and then causes the vendor data to be compared with the vendor information. As such, information about the product 12 can then be retrieved from one or more vendors by accessing the vendor data 26 associated with the vendor information 14. Vendor data 26 can be any information related to describing the product, product price, and product availability or information related to the vendor such as location, business hours, and special remarks. In one embodiment, vendor data 26 may be useful to comparison shop between different vendors. The comparison may be price-related only, or alternatively may take into account other factors such as time to delivery, service and warranties. As previously noted, data processing of the system may also relate to services. Thus, differences in the service characteristics may be retrieved as well. Additionally, comparing the vendor data 26 with the vendor information 14 may include a comparison with the user data 28. During use, the server 20 can be configured to anonymize user requests before such requests are sent to vendors.

After comparing the vendor data 26 with the vendor information 14, the processor 32 instructs the vendor compilation program 22 to construct a vendor output 34 based on the comparison of the vendor data 26 with the vendor information 14 (step 210). The vendor output 34 is then transmitted to the portable device 16 (step 212). In an embodiment, the portable device 16 may visually display the resulting vendor output 34 to the user. In another embodiment, the portable device 16 may audibly communicate the vendor output 34 to the user. The user may, directly from the portable device 16, execute a transaction 36 in response to the vendor output 34 such as ordering the product, requesting more information, or other some other action related to the product 12 (step 216). The method may include secure transaction mechanisms and provide a variety of payment choices including using a credit or debit card, or billing the user. Coupon codes, scanned or already stored on the portable device 16 may be processed while executing the transaction 36. Although the embodiment shown in FIG. 2 describes the general steps of the present method of data processing 200 by the system 10, the following embodiments provide additional examples of how the portable device 16, configured for electronic commerce transactions, can function.

For example, in an embodiment for shopping, vendor information 14 relating to products 12 such as groceries are acquired at home by the user prior to shopping by using the portable device 16. Desired quantities of the products 12 may be entered by pressing digits on the portable device 16, or by repeatedly scanning/reading the same vendor information 14. Images of the vendor information 14 are translated by software on the portable device 16 which transmits the vendor information 14 to a server 20.

Next, the processor 32 compares the vendor information 14 with the vendor data 26 and creates a shopping list to match with available vendors, while considering special offers, manufacturer's coupons, and other bundling offers. The processor 32 causes the vendor output 34 to be constructed such as best or preferred options, and transmits the vendor output 34 to the portable device 16 taking into account such factors as proximity to user's location. In an embodiment, the user's location may be retrieved from the user database 28. In another embodiment, the portable device 16 may include technology to utilize a location-based service system or may include technology to utilize a global positioning satellite system. The systems are configured to locate the portable device 16 within a geographical region in order to retrieve the user's location for constructing the vendor output 34.

Several embodiments of this scenario, still within the scope of the present disclosure, may include such options as including home delivery of the ordered products. Another embodiment allows a shopping list to be transferred to a vendor who then collects the products for pick-up by the user. Substitute products could be displayed according to user's preferences, which may specify such options as whether a non-organic food product may be substituted for an organic food product, or whether generic products may be substituted for brand name products.

In another embodiment relating to proximity price comparison, vendor information 14 is transmitted from the portable device 14 to the server 20. In response, the server 20 responds with the best offer for that product in the user's area. In addition to the product's prices being displayed, prices for comparable products could be displayed as well. The method of this embodiment may be used in conjunction with special promotions, such as displaying the previous year's version of a product for a discount.

In another embodiment relating to a reverse auction, the portable device 16 reads the vendor information 14 of a product 12 that the user desires to purchase for the lowest possible price. The portable device 16 then transmits the vendor information 14 along with anonymous user information to the server 20. At least one vendor accesses the server 20 to find out which products 12 are being sought by users wherein the identity of the user is not revealed to the vendor. In response, the vendor generates the vendor output 34 such as, for example, a price quote for the product 12. The user may then retrieve, via the portable device 16, the vendor output 34 associated with the now known vendor. Based on the vendor output 34, the user may then elect to execute the transaction based on the vendor output 34.

In an embodiment relating to ticket sales, event showtimes such as movie listings can be listed with the vendor information 14 in various advertising locations including but not limited to newspapers, periodicals, on posters, or on a venue store front. The vendor information 14 may contain event-specific information including information such as theater name, screen number, sequence number of shows in day, and point-of-sale number. During use, the user acquires the vendor information 14 of a desired movie via the portable device 16. The vendor information 14 is then transmitted to the server 20. In response, the processor 32 locates the vendor output 34 such as show time information and then causes the vendor output 34 to be transmitted to user with price. The user selects a ticket quantity and confirms the purchase via the portable device 16. The processor 32 then causes the transaction to be completed, pays the theater and sends confirmation to point-of-sale. The tickets are printed and/or are available for pickup by the user. Although this embodiment illustrates purchasing movie ticket, the method of the present disclosure can be similarly used for purchasing tickets to all kinds of venues.

In an embodiment relating to vending machines, vendor information 14 identifying a product 12 (while also identifying the vending machine) is displayed on the face of the vending machine. The vendor information 14 for the desired product 12 is acquired by the portable device 16, payment is made using the portable device 16 and the desired product 12 is then dispensed. The present disclosure is configured for a plurality of dispensing machines, or self service item. Stores allowing self-checkout can use this embodiment allowing a user to checkout while selecting products 12 directly in the store's aisles, and thus, eliminate the use of expensive automated checkout machines.

In an embodiment relating to home bill payment, vendors such as utilities, stores, and credit card companies, print various vendor information 14 on invoices sent to a user. The vendor information 14 includes a unique business identification code corresponding to the user, the user's account number, and amount of invoice. During use, the user acquires the vendor information 14 relating to the invoice by using the portable device 16. Once the vendor information 14 is transmitted to the server 20, various payment methods can be automatically handled by the processor 32 (e.g., credit card, print check, add to phone bill) and payment is sent to the appropriate business to simplify electronic bill payment.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected by the following claims.

1. A method in a data processing system, the method comprising the steps of:
displaying vendor information in a readable format to a user;
reading the vendor information;
transmitting the vendor information to a server;
retrieving vendor data associated with the vendor information from the server;
comparing the vendor data with the vendor information to construct a vendor output;
transmitting the vendor output to the user; and
in response to the vendor output, executing a transaction by the user with the server.

2. The method in a data processing system of claim 1, wherein the vendor information comprises a commercial code.

3. The method in a data processing system of claim 2, wherein reading the vendor information comprises translating the commercial code to be readable by the server.

4. The method in a data processing system of claim 1, wherein the readable format is an electronic readable format.

5. The method in a data processing system of claim 1, wherein the readable format is a machine readable format.

6. The method in a data processing system of claim 1, wherein reading the vendor information comprises digitally acquiring the vendor information with a portable device.

7. The method in a data processing system of claim 6, wherein the portable device is a cellular phone.

8. The method in a data processing system of claim 6, wherein transmitting the vendor output comprises visually displaying the vendor output from the portable device to the user.

9. The method in a data processing system of claim 1, wherein comparing the vendor data with the vendor information further comprises comparing user data stored in the server with the vendor information stored in the server.

10. The method in a data processing system of claim 1, wherein the vendor data comprises a lowest price for the vendor information.

11. The method in a data processing system of claim 10, wherein constructing the vendor output comprises associating the lowest price with a specified vendor.

12. An electronic readable medium device encoded with instructions that cause a data processing system to perform a method, the method comprising the steps of:
displaying vendor information in an electronic readable format to a user;
electronically reading the vendor information;
transmitting the vendor information to a server whereupon the server constructs a vendor output in response to the vendor information; and
receiving the vendor output constructed by the server wherein the user executes a transaction with the server in response to the vendor output.

13. The electronic readable medium device encoded with instructions that cause a data processing system to perform a method of claim 12, further comprising transmitting billing information from the user to the server.

14. The electronic readable medium device encoded with instructions that cause a data processing system to perform a method of claim 12, wherein electronically reading the vendor information comprises digitally acquiring the vendor information with a portable device.

15. The electronic readable medium device encoded with instructions that cause a data processing system to perform a method of claim 14, wherein the portable device is a cellular phone.

16. The electronic readable medium device encoded with instructions that cause a data processing system to perform a method of claim 15, wherein receiving the vendor output comprises visually displaying the vendor output from the portable device to the user.

17. An electronic readable medium device encoded with instructions that cause a data processing system to perform a method, the method comprising the steps of:
receiving vendor information from a user;
constructing a vendor output in response to the vendor information; and
transmitting the constructed vendor output to the user wherein the user executes a transaction in response to the vendor output.

18. The electronic readable medium device encoded with instructions that cause a data processing system to perform a method according to claim 17, further comprising displaying vendor information in an electronic readable format to the user.

19. The electronic readable medium device encoded with instructions that cause a data processing system to perform a method according to claim 18, further comprising electronically reading the vendor information

20. The electronic readable medium device encoded with instructions that cause a data processing system to perform a method according to claim 19, wherein electronically reading the vendor information comprises digitally acquiring the vendor information with a portable device.

21. The electronic readable medium device encoded with instructions that cause a data processing system to perform a method according to claim 17, wherein the portable device is a cellular phone.

22. The electronic readable medium device encoded with instructions that cause a data processing system to perform a method according to claim 22, wherein transmitting the vendor output comprises visually displaying the vendor output from the portable device to the user.

23. A data processing system, comprising:
a portable device having a reader, the reader being configured to read vendor information;
a server in communication with the portable device, the server having a memory which includes a vendor compilation program which receives the vendor information from the portable device and compares the vendor information with vendor data stored in the memory; and
a processor in communication with the server which controls the vendor compilation program wherein the processor instructs the vendor compilation program to construct a vendor output based on the comparison of the vendor information with the vendor data.

24. The data processing system of claim 23, wherein the portable device is a cellular phone.

25. The data processing system of claim 23, wherein the reader is a digital camera.

26. The data processing system of claim 23, wherein the reader is a radio frequency identification tag.

27. The data processing system of claim 23, wherein the reader is configured to digitally acquire the vendor information.

28. The data processing system of claim 23, wherein the vendor information is a commercial code.

29. The data processing system of claim 28, wherein the reader is configured to translate the commercial code.

30. The data processing system of claim 23, wherein the portable device and the server are configured to wirelessly communicate with each other.

31. The data processing system of claim 23, wherein the server is configured to transmit the vendor output to the portable device.

32. The data processing system of claim 23, wherein the memory includes user data.

33. The data processing system of claim 32, wherein the user data includes billing information relating to the user.

34. The data processing system of claim 23, wherein the vendor compilation program is configured to compare the vendor information with the user data in order to construct the vendor output.

35. In a portable device including a display device, a processor and a memory coupled to the processor, a method for enabling E-Commerce, the method comprising:
electronically reading vendor information from a vendor product;
interpreting the vendor information to form transmissible vendor information;
transmitting the interpreted vendor information to a server;
after transmitting the interpreted vendor information to the server, receiving a vendor output from the server, the vendor output generated by comparing the vendor information to retrieved vendor data; and
detecting user execution of a transaction, the transaction based on the vendor output.

36. The method in a portable device of claim 35, wherein the vendor information comprises a commercial code.

37. The method in a portable device of claim 35, wherein electronically reading the vendor information comprises digitally acquiring the vendor information with the portable device.

38. The method in a portable device of claim 35, wherein the portable device is a cellular phone.

39. A data processing system, comprising:
a portable device having a reader, the reader being configured to read vendor information from a vendor product; and
a server in communication with the portable device, the server having a processor and a memory coupled to the processor, the processor configured to:
receive vendor information from the portable device,
retrieve vendor data associated with the vendor information in response to receipt of the vendor information,
cause the vendor information to be compared to the vendor data via a vendor compilation program to construct a vendor output, and
transmit the vendor output to the portable device, the vendor output enabling a user to selectively execute a transaction to purchase the vendor product.

40. The data processing system of claim 39, wherein the portable device is a cellular phone.

41. The data processing system of claim 39, wherein the reader is a digital camera.

42. The data processing system of claim 39, wherein the reader is configured to digitally acquire the vendor information.
